(19) United States
(12) Patent Application Publication
(10) Pub. No.: US 2012/0246033 A1
(43) Pub. Date: Sep. 27, 2012

(54) METHODS AND SYSTEMS FOR CONVERTING INTENT INTO A TRANSACTION

(75) Inventor: Bruce Keiser, Monte Sereno, CA (US)

(73) Assignee: Per Choice, Inc., Monte Sereno, CA (US)

(21) Appl. No.: 13/072,607

(22) Filed: Mar. 25, 2011

(51) Int. Cl. G06Q 30/00

(52) U.S. Cl. 705/27.1

(57) ABSTRACT

The invention relates to a method and a system for converting an online interaction into a brick-and-mortar or online transaction between an Internet user and a plurality of merchants via the Internet. This invention assesses a buyer's purchasing intent and provides offers based on the buyer's purchasing intent and the buyer's purchasing score. The method involves maintaining a database of buyer attributes and receiving from a buyer a request for one or more offers. After receiving a request, a special intent server determines a purchasing score of the buyer based, at least in part, on information stored in the database of buyer attributes. Next, after a purchasing score is determined, the request and the purchasing score are transmitted to one or more offer sources. Finally, the intent server and the method then receives one or more offers from the offer sources and provides them to the buyer via the Internet.

### BACKGROUND OF THE INVENTION

The present invention generally relates to facilitating commercial transactions between Internet users and merchants and certain embodiments teach a process for converting an online interaction between a business and a consumer into an online transaction or a transaction at a physical store.

For a consumer, shopping online or in a brick-and-mortar store are traditionally two separate things, each having unique advantages or disadvantages. Online, one could shop from the comfort of his or her home, and force businesses to compete on price alone. In brick-and-mortar stores, customers can physically view the product and avoid shipping costs. Until now, there has not been a way for customers to demand the best of both worlds.

From a business' perspective, whether online or brick-and-mortar, the business commonly relies on market indicators, historical sates data, and a combination of other statistics to anticipate demand and to be able to craft advertisements/sales to lure target consumers. This form of market forecasting and approximation can be unreliable, inaccurate, and inefficient. Until now, there has not been a way for businesses to easily ascertain the likelihood of a customer to make a purchase and to pin down a browsing customer right before s/he decides to purchase.

Overall, the examples herein of some prior or related systems and their associated limitations are intended to be illustrative and not exclusive. Other limitations of existing or prior systems will become apparent to those of skill in the art upon reading the following Detailed Description.

### SUMMARY OF THE INVENTION

This invention combines the vast selection and convenience of the Internet to increase the customers bargaining power in the real world. One aspect of the present invention allows consumers to leverage the increased bargaining power from the Internet to traditional brick-and-mortar operations. Another aspect of the present invention creates a shorthand mechanism whereby businesses can make an automated decision on granting people or businesses incentives to make a purchase.

One aspect teaches a method and system for converting an online interaction, between an Internet user and a plurality of businesses, into a transaction at a physical store by assessing a buyer's purchasing intent and providing offers based on the purchasing intent and buyer purchasing score. The method comprises the steps of maintaining a database of buyer attributes; receiving from the buyer a purchasing intent for one or more offers; determining a purchasing score of the buyer based, at least in part, on information stored in the database of buyer attributes; transmitting the request and the purchasing score to one or more offer sources; receiving the one or more offers from said one or more offer sources; and providing the one or more offers to the buyer.

Other persons and entities beside consumers and businesses may utilize the invention without departing from the spirit of the invention. The reference to a “consumer” and a “business” is primarily a simplified representation and generally denotes any buyer-seller association. This can encompass other dealings such as those between a retailer and a wholesaler, a consumer and third-party aggregator, a purchasing decision-maker and a manufacturer, a dealer and a supplier, a small business and a merchant, a company and a supplier, and many others. This can also encompass transactions or dealings between non-commercial entities, such as individuals, charities, organizations, etc. For example, the buyer-seller association can exist among two individuals: one individual seeking to buy/trade a good or solicit a service from another individual or private seller. Moreover, what can be bought and sold between a buyer and seller can include, among other things, goods, products, services, etc. that can be real or virtual (e.g., virtual greetings, virtual gifts).

Other advantages and features will become apparent from the following description and claims. It should be understood that the description and specific examples are intended for purposes of illustration only and not intended to limit the scope of the present disclosure.

### BRIEF DESCRIPTION OF THE DRAWINGS

The features and characteristics of the present invention will become more apparent to those skilled in the art from a study of the following detailed description in conjunction with the appended claims and drawings, all of which form a part of this specification. In the drawings:

FIG. 1 (and the following discussion) provides a brief, general description of a representative environment in which the invention can be implemented.

FIG. 2 is a block diagram illustrating an exemplary architecture of an intent server configured to perform the various functionalities of the intent platform.

FIG. 3 depicts an exemplary webpage through which the user can gain access to the intent platform.

FIG. 4 illustrates a representation of a list of offers sent to a user;

FIG. 5 is a flow diagram depicting a process for transmitting an offer to a user; and

FIG. 6 is a high-level block diagram showing an example of the architecture for a computer system.

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

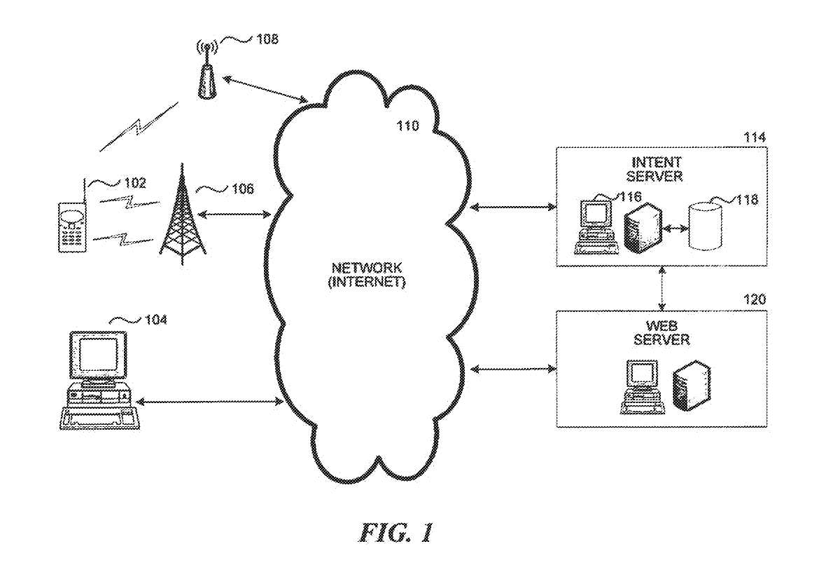

FIG. 1 and the following discussion provide a brief, general description of a representative environment in which the invention can be implemented. The method and system provides a platform in which individuals and businesses (generally termed a “buyer”) can state their intention (generally termed “purchase intent”) to purchase a good and/or a service (actual or virtual). The purchase intent can include as relevant one or more of information on whom the buyer is, what the buyer is interested in buying, a proximity of where the buyer wants to make the purchase, and address for delivery, when the buyer is going to spend money and how the buyer prefers to purchase. In exchange for providing this information, the deliberating buyer can find discounts, deals, promotions, coupons, incentives, rebates, and more (generally termed “offers”) relating to this purchase intent and the transaction can occur immediately.

Along with the ability of a buyer to broadcast an intent to purchase, the platform also allows an opportunity for followers of those statements (generally termed a “seller”) to perceive the accompanying demographic factors and buyer attributes bundled with that purchase intent. As discussed above, the platform provides buyers an ideal market where sellers compete on price, quality, and/or service for the buyers' business. Also, sellers can isolate a data point that is more credible and realistic than market projections and statistics. In turn for the readiness of the buyer to commit to a purchase, the seller is willing to offer an attractive deal to the prospective customer. As a result, the platform facilitates the creation of a mutually beneficial transaction between the buyer and seller.

In another embodiment, a buyer and seller can both be users of the platform. In this instance, the buyer-user broadcasts a purchase intent to other users of the platform. Other users of the platform may be able to fulfill the request or purchase intent of the buyer-user and thus be able to offer their goods or services to the buyer-user (as “offer providers”). The offer providers have the opportunity to evaluate the buyer-users purchase intent and purchasing score (or a variant for privacy purposes) and can then bid for the buyer-users patronage. As such, these offer providers can be a private seller, a small business, commercial company, an organization, etc.

After one or more offers are provided to the buyer, the buyer can accept the offer in a variety of ways. In one embodiment, the buyer can tentatively accept the offer and complete the transaction in the future on the offer platform, the offer source's website or at the store. In another embodiment, the buyer can immediately commit to accepting, completing, and purchasing the offer all at once (thereby, redeeming the offers discount without delay). In the latter instance, the buyer commits to or accepts the offer and takes the next steps to complete the transaction. This includes submitting payment information either directly on the website/user interface associated with intent platform or on the website/user interface associated with the offer source. The user can then instantaneously receive the goods/service or coordinate the delivery/scheduling of the (real or virtual) purchase for a time in the future.

Moreover, the platform tracks all of the buyers purchase intents, offers (accepted, rejected, offered but unaccepted, etc.), and transactional activity to determine a purchasing score. The purpose of the purchasing score is two-fold in that it allows a buyer to gain access to better offers and allows a shorthand way for a business to evaluate the seriousness of a buyer's purchase intent. As such, the platform rewards reliability and loyalty, which arise with devoted customers, with dependable sellers, and as between repeat buyers and sellers. Additionally, a serious buyer who immediately commits to accepting the offer and completing the purchase can be rewarded with more attractive offers or an augmented purchasing score.

The following illustration describes a simplified transaction. However, other instantiations of the invention may include greater complexity. As an example, in one embodiment, a buyer submits a purchase intent which states that she is willing to spend up to $700 in the coming weekend for a washer. The buyer enters the platform, and submits his purchase intent, along with some additional personal information, to obtain a purchasing score. Because this is the first time that the buyer is entering the platform, she is given a median purchasing score. The median score can be a neutral to slightly positive reflection of the buyer's commitment to make a purchase.

Next, sellers on the platform, such as Sears, Best Buy, Lowe's, Home Depot, and others, review the buyer's purchase intent. As an example, Seller A is willing to provide a $200 discount if the buyer is willing to come into the store to make her purchase, while Seller B is willing to provide a $225 coupon for the purchase of a washer and an additional $200 discount for the purchase of a dryer. Seller C is willing to provide a $300 discount if she immediately commits to purchasing a top-loading washer online. After reviewing all of the offers on the platform, along with the terms of each, buyer arrives at a decision and tentatively accepts Seller B's offer. Buyer's completion of the transaction with Seller B at the store over the weekend results in the buyer spending $500 for the washer and an additional $500 for a new dryer.

At the culmination of the transaction, the platform registers the completion of the transaction and considers that the buyer's purchasing intent was substantially similar, if not identical to her actual purchase. Because the buyer's purchasing intent accurately reflected the buyer's actual purchase, the buyer's purchasing score will likely increase. Moreover, because the buyer spent more than she anticipated in her purchase intent, her purchasing score may further increase as well. The good credit she earned in her purchasing score will yield even better offers in a future purchase intent submitted on the intent platform. By the same token, sellers can more easily ascertain the reliability of a buyer to follow-through with an offer and thus, are more apt to provide attractive discounts to lure buyer to the store for her next transaction.

As demonstrated in this example, a buyer's purchase intent and personal data are valuable information and ought to be jealously guarded to protect the consumer's interest. In comparison, the intent platform also allows a buyer to share his/her experience with an offer/transaction via email, social media networks, blogs, and/or feeds. In either case, the buyer can selectively choose what parameters of the purchase intent and personal data s/he is willing to divulge to offer sources and/or publicize to others. As a result, the intent platform becomes the buyer's preferred forum by which s/he can choose or not choose to share this most valuable information.

Although not required, aspects of the invention may be described below in the general context of computer-executable instructions, such as routines executed by a general-purpose data processing device (e.g., a server or a personal computer). Those skilled in the relevant art will appreciate that the invention can be practiced with other communications, data processing, or computer system configurations, including: wireless devices, Internet appliances, hand-held devices, personal digital assistants (PDAs), wearable computers, all manner of cellular or mobile phones, multi-processor systems, microprocessor-based or programmable consumer electronics, set-top boxes, network PCs, mini-computers, mainframe computers, and the like. For example, a buyer, in search of a good deal, could potentially be at a store, and submit a purchase intent on a personal computing device. The instantaneous feedback from the intent platform could counsel the buyer to make the purchase at another store. Indeed, the terms “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

The invention can also be practiced within or as an application on an existing web-based service provider or social media network. For example, an online auction and shopping website in which individuals and businesses buy and sell a broad variety of goods and services (both real and virtual) can implement aspects of the invention within the current capabilities and services. As an example, in one embodiment, a buyer can broadcast a purchase intent as an auctioned item whereby offer sources can bid or submit offers. As another example, the invention can be practiced on a centralized network of online communities which feature discussion forums and a classified advertisement section (paid or free) for jobs, housing, services and more. The invention can also be practiced on a wide variety of social media websites among a network of individuals with social affinities. In all cases, the platform can be integrated as part of the functionality of the website or as an application that is peripheral to the online website.

Aspects of the invention may be stored or distributed on tangible computer-readable media, including magnetically or optically readable computer discs, hard wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet, other networks (including wireless networks), or a propagated signal on a propagation medium (e.g., an electromagnetic wave(s), a sound wave, etc.) over a period of time. In some implementations, the data may be provided on any analog or digital network (packet switched, circuit switched, or other scheme).

As shown in FIG. 1, a buyer may use a personal computing device (e.g., a phone 102, a personal computer 104, electronic notebook, etc.) to communicate with a network. The term “phone,” as used herein, may be a cell phone, a personal digital assistant (PDA), a portable email device (e.g., a Blackberry), a portable media player (e.g., an ilPod or iPad), or any other device having communication capability to connect to the network. In one example, the phone 102 connects using one or more cellular transceivers or base station antennas 106 (in cellular implementations), access points, terminal adapters, routers, or modems 108 (in IP-based telecommunications implementations), or combinations of the foregoing (in converged network embodiments).

In some instances, the network 110 is the Internet, allowing the phone 102 (with, for example, WiFi capability) or the personal computer 104 to access web content offered through various web servers. In some instances, especially where the phone 102 is used to access web content through the network 110 (e.g., when a 3G or an LTE service of the phone 102 is used to connect to the network 110), the network 110 may be any type of cellular, IP-based, or converged telecommunications network, including, but not limited to, Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

In some instances, a buyer uses one of the personal computing devices (e.g., the phone 102, the personal computer 104, etc.) to connect to an intent server 114 through the network 110. In one embodiment, the intent server 114 comprises a server 116 coupled to a local database 118. The term “intent server,” as indicated herein, refers to a server station or other computing apparatus capable of hosting a web service that is accessible by other computing systems (e.g., personal computer 104) through, for example, the Internet.

The intent server 114 illustrated in FIG. 1 operates an intent platform. The term “intent platform” as indicated herein, refers to a suite of operations that may include, for example, querying multiple sources (e.g., offer sources) to identify offers, receiving from a buyer a request for offers or an intent, creating an account for the buyer to record the buyer's attributes (discussed further below) and registration information, determining a purchasing score and transmitting buyer requests for offers to offer sources, etc. As will be explained in further detail herein, the intent server 114 incorporates one or more functional units to achieve each of the above discussed functionalities.

In some instances, the intent server 114 also operates as a web server to enable the intent platform to be displayed through a webpage. In such instances, the intent server 114 may operate additionally as a web server or may be coupled to a separate web server to provide the web functionalities.

As shown in FIG. 1, the personal computing devices and the intent server 114 are connected through the network 110 to one or more web servers (e.g., web server 120). Each web server corresponds to a computing station that enables a third party (e.g., a retail website through which a buyer can scrutinize offerings, a website that aggregates multiple retailers, etc.) to host, for example, an intent platform that can be accessed through the network 110.

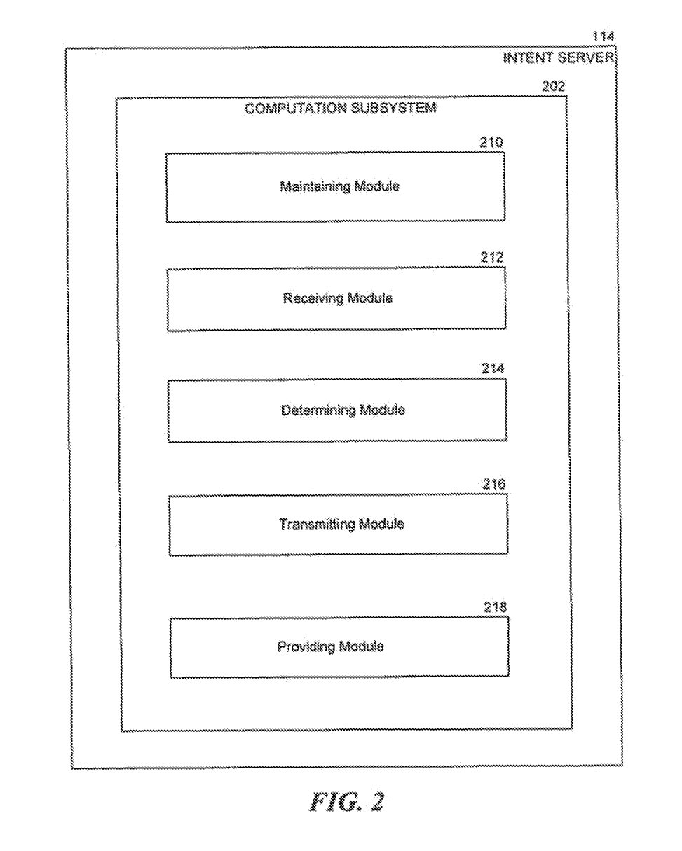

FIG. 2 is a block diagram illustrating an exemplary architecture of an intent server 114 configured to perform the various functionalities of the intent platform. In the illustrated embodiment, the intent server 114 includes a computation subsystem 202, which performs various functions related to the intent platform. The computation subsystem 202 can be implemented by using programmable circuitry programmed by software and/or firmware, or by using special-purpose hardwired circuitry, or by using a combination of such embodiments. In some instances, the computation subsystem 202 is implemented as a unit in a processor of the intent server.

The computation subsystem 202 includes a maintaining module 210. The maintaining module may be configured to communicate with external entities to maintain a database of buyer attributes. In one example, the database of buyer attributes is stored on a separate server distinct from the intent server and thus the database of information stored on the separate server is accessed and retrieved by the maintaining module 210 of the intent server 114. In another example, the database of buyer attributes is stored on the intent server 114 itself and the maintaining module does not need to communicate with external entities to access the database of buyer attributes.

The computation subsystem 202 also includes a receiving module 212 that, in some instances, is configured to communicate with external interfaces to receive a buyer request from the user. In one example, the buyer uses a personal computing device to open a website of the intent platform. The web server operating the intent platform receives a request sent by the user (e.g., simple selection to start the intent platform, parameters of a request, etc.) and transmits it to the receiving module 210 of the intent server 114. The receiving module 212, in some instances, receives the buyers requests and relays the requests for further processing by the intent server 114. Further on, the receiving module 212 is also configured to receive from one or more offer sources the offers requested by the buyer.

The computation system 202 also includes a determining module 214. The determining module 214 is configured to determine a purchasing score of the buyer based, at least in part, on information stored in the database of buyer attributes. In some instances, the determining module 214 communicates with the maintaining module 210 to access and retrieve information stored in the database of buyer attributes. In other instances, the determining module 214 can directly communicate with the database of buyer attributes. After communicating with the database, the determining module 214 calculates the buyers purchasing score and then works in conjunction with a transmitting module 216 (discussed below) to transmit the buyers purchasing score to offer sources.

The computation system 202 also includes a transmitting module 216. The transmitting module 216 is configured to transmit the buyers request, along with the buyers purchasing score to one or more offer sources. The transmitting module 216 works in association with the receiving module 212 and the determining module 214 to obtain, respectively, the buyers request and the buyers purchasing score. Upon receiving the necessary information, the transmitting module 210 is able to transmit the buyers request and the calculated purchasing score to one or more offer sources from which the offers are obtained. The offer sources can use the buyer's purchasing score as one determinant to what kind of discounts are offered to the buyer.

The computation subsystem 202 also includes a providing module 214 that is configured to provide the one or more offers to the buyer. The providing module 214 works in conjunction with the receiving module 212 and transmitting module 216 to identify and generate the various offers available to the buyer based on the buyer's request and purchasing score. In some instances, the providing module 214 generates a list of offers for the buyer replete with detailed descriptions and images. In some instances, the providing module 214 is limited by display constraints or the specific transmission mechanism chosen by the buyer. For example, the providing module 214 may provide solely a text-based list when displaying on a personal computing device. In some instances, the providing module 214 determines a protocol or other communication requirement based on the transmission mechanism specified by the user in order to generate the one or more offers. In one example, the providing module 214 adds suitable message headers when displaying an email message.

The receiving module 212, in some instances, can be further configured to receive a buyers registration information or login. In some instances, the receiving module 212 works in association with the database of buyer attributes to establish and store the buyer's registration and personal information. Examples of such information include: age, income, location and other demographics along with the buyers history of past purchases and/or requests. Additional examples of such information are explained in detail further below. The receiving module 212 can also coordinate with the determining module 214 such that when the receiving module 212 receives a buyer's registration information, the information facilitates the calculation of the buyers purchasing score by the determining module 214.

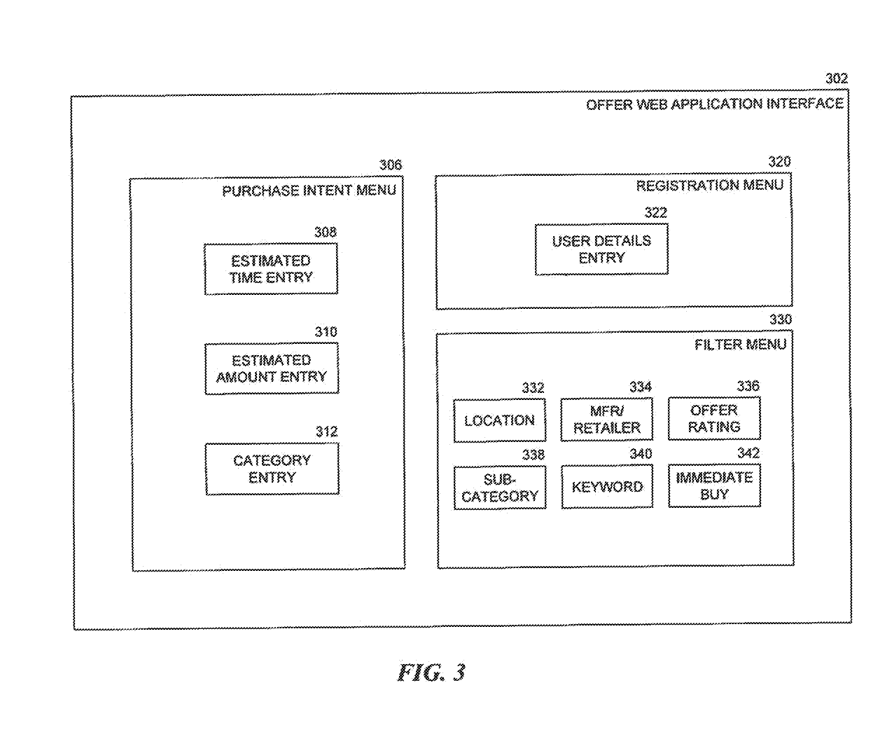

FIG. 3 depicts an exemplary webpage 302 through which the user can gain access to the intent platform. The webpage 302 includes a purchase intent menu 306 through which the buyer can indicate one or more parameters relating to the anticipated purchase. In some instances, the purchase intent menu 306 includes an estimated time entry block 308, through which the buyer can indicate a future date or time period for when the anticipated purchase may occur. Additionally, the preferences menu 306 may include an estimated amount entry block 310. Using this block, the buyer can indicate an estimated range or actual dollar amount for the anticipated purchase. The purchase intent menu 306 may also include an entry by which a user can specify a category (e.g., good, service, both real and virtual) of the anticipated purchase 312. In some instances, the intent platform saves a buyer's past requests such that the estimated time, estimated amount, and/or purchase category previously entered by the buyer are displayed (not shown in FIG. 3) for the buyer's benefit. In addition to the above blocks, the purchase intent menu 306 may also include a variety of other entry options such as a frequency (or the periodic basis) for making a purchase, etc.

In some instances, the webpage 302 may include a registration menu 320 to allow a buyer to enter user details to establish (or login to) a personalized registration account. The intent server uses details (e.g., user name, password, user's email address, etc.) entered by the buyer through a user details entry block 322.

In some instances, the webpage 302 includes a filter menu 330 to provide the buyer a mechanism by a purchase intent can be narrowed. In one example, the buyer can use a location block 332 to limit the offers to a specific geographic region or a distance of the offer source from the buyer. In another example, the user can use the subcategory block 338 to restrict the category entry 312 (e.g., home improvement) to a more specific category (e.g., outdoor furniture, gardening equipment). In another example, the buyer can limit the offers to a desired manufacturer of a good, a particular retailer with the MFR/retailer block 334, a particular source or brand name of a virtual good or service. In another example, the buyer can filter the offers based on a particular rating of the offer source (e.g., only sources with 90% positive feedback) with the offer rating block 336. Other examples include: a keyword or tag 340 associated with the offer (e.g., wedding, salon), whether the offer is available for immediate purchase 342.

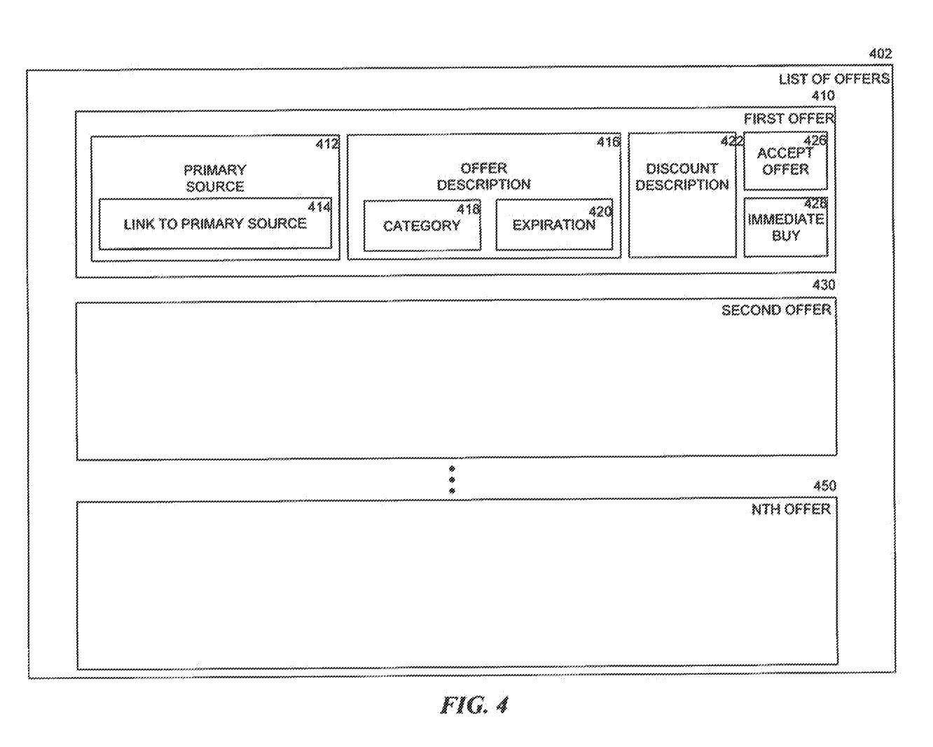

FIG. 4 illustrates a representation of one or more offers transmitted to a user. In the embodiment illustrated in FIG. 4, one or more offers are transmitted as webpage 402 displaying a list of offers on the buyer's computer 104. As indicated above, the list of offers may also be provided to the buyer in the form of a text-based display on a personal computing device or an html email message. In some instances, the webpage 402 includes one or more blocks (e.g., 410, 430, 450, etc.), each block corresponding to an offer from an offer source.

Each offer includes a variety of details. In a first instance, the first offer 410 includes an icon or visual representation of the primary source 412 and a link to the primary source 414. A primary source corresponds to an entity through'which the buyer can complete the purchase or transaction. In one embodiment, a buyer can peruse in more detail the product or service offered by the offer source. Further, the user can even tentatively accept the offer 426 and conditionally receive the discount, pending further actions by the buyer. In another embodiment, the user can commit to the offer for immediate purchase 428 and complete the transaction. In one embodiment, the offer source may be a local database (e.g., third-party aggregator) that retrieves from a plurality of primary sources. In at least another embodiment, the intent platform directly searches primary sources as an offer source. In either case, the intent platform directly can provide a hyperlink 414 to the primary source's website and the buyer to establish a connection with the primary source and possibly complete the transaction or purchase.

In addition the link to the primary source 414, the list of offers 402 may also include, for example, an offer description 416 with details relating to a purchase category 418 or expiration 420 date, period of availability or time duration for the displayed offer, geographic location (not shown) of the offer source, a description 422 of the discount that can include a pre-savings price and a post-savings price, and an option to tentatively accept the offer 426, etc.

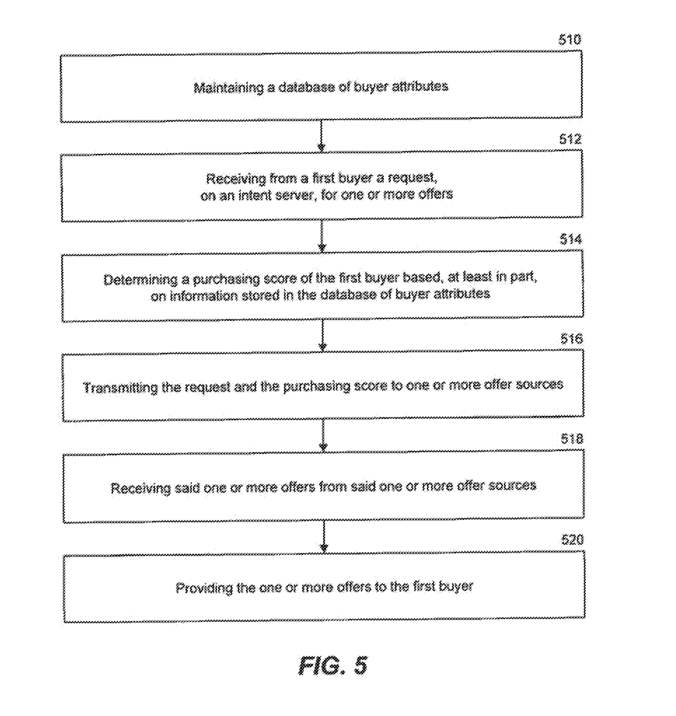

FIG. 5 is a flow diagram depicting a process for converting an online interaction into a brick-and-mortar transaction. As indicated in block 510, an intent platform maintains a database of buyer attributes. In one example, the database of buyer attributes may be integrated in or separately partitioned from the intent server 114. In either case, the database includes a vast array of data. In one instance, the database can include a number of demographics including: gender, age, income, buyer location at a given time, a geographic location of a buyer's residence, highest level of education attained by the buyer, profession, employment status, whether a buyer owns, leases, rents, etc. his or her home, disability, and a buyer's mobility in terms of travel time to work or number of vehicles owned.

In another instance, when a buyer has previously interacted with the intent platform, the database can include additional information pertaining to the number of past requests, number of offers that were accepted in the past, time since the last request or the last accepted offer, the length of time a buyer has been a registered user, prevalence of offers accepted by the buyer, and the total amount of money spent on past offer(s). With this information, the database can amass a volume of data analytics which can be used to ascertain a buyer's likelihood of purchase and the veracity and accuracy of a buyer's purchase intent (e.g., comparing a past offer that was accepted by the buyer to the corresponding request). All of the above data analytics about the buyer can factor into the determination of a purchasing score (discussed below).

At block 512, the intent platform receives from a first buyer a request, on an intent server, for one or more offers. The request can be sent in many different ways. For example, the request can be sent via e-mail, a mobile application, an interface on a social network website, through a secured webpage, etc. If information (e.g., attributes of the buyer) relayed between networks of computers is deemed personal or private information, it can be encrypted before it is sent from one computer to another.

As indicated above, the buyer's request can include a simple indication or selection to initiate the intent platform. In the same or another instance, the buyer can submit the parameters of actual purchase intent itself. As such, the request is more complex and includes additional parameters. When entering this detailed request, the parameters of the purchase intent can include, for example, an estimated time the buyer will make the purchase, an estimated amount of money that is budgeted or the buyer is willing to spend, and a particular category of the purchase (e.g., good or service; actual or virtual, type of product or service). Other embodiments may include additional parameters.

At block 512, if the buyer has registered his or her personal information with the intent server, the intent platform can refer to the buyer's personal preferences associated with the registration and previous activity (e.g., requests, offers). If however the buyer does not have a prior registration, the intent platform provides the buyer an option to register for a personalized account. In either scenario, the intent platform can save the buyer's activity, including the request for one or more offers, for the purpose of creating a new registration for the buyer.

At block 514, the intent platform determines a purchasing score of the buyer based, at least in part on information stored in the database of buyer attributes. A purchasing score is a shorthand way, similar to a credit score, by which a seller can quickly ascertain the likelihood of a buyer to consummate an anticipated purchase and allows a quasi-automated decision on whether to grant that buyer (e.g., person, business) an attractive incentive to make that purchase. In some embodiments, when there is no data or information on a buyer and a purchasing score cannot be calculated, the purchase intent can still be transmitted to the offer source for further processing. However, when the information is available, the database of buyer attributes can be utilized to determine a purchasing score.

As discussed above, data analytic techniques can be employed on the platform to inspect, clean, transform, and model data with the goal of highlighting useful information, supporting decision-making, and suggesting conclusions. The platform mines and aggregates particular points of data to enhance statistical knowledge and provide predictive indicators. In a simplified embodiment, the platform collects information regarding the type of offers that are frequently accepted and converted into a transaction. Offer sources can, in turn, benefit from knowing this information in order to craft more attractive incentives in the future. In another simplified embodiment, the platform classifies data relating to the purchase intent to extract patterns and gauge consumer demand for certain products or services. Armed with the observations from data analytics, the platform transforms volumes of raw data into business intelligence and an informational advantage for both internal and external processes.

While different scoring models can be employed, generally when a buyer has been provided an offer from an offer source and the buyer accepts the offer by completing the transaction/making a purchase, the purchasing score of the buyer will increase. Similarly, when a buyer submits a purchasing intent with parameters not unlike the actual purchase, the purchasing score of the buyer will increase. In some embodiments, there are no instances in which the purchasing score of a buyer will decrease. In other embodiments, there may be instances in which a buyer's purchasing score may decrease. While the purchasing score can be determined and be modified in a variety of ways, the final purchasing score is primarily derived from data stored in the database of buyer attributes.

At block 516, the intent platform transmits the request and the purchasing score to the offer source(s). The details of the buyer's request and the buyer's filtering options can be utilized by the offer source(s) to narrow down the service/product offerings to the buyer. While the intent server determines a purchasing score for the buyer, the interpretation of the purchasing score will vary by offer source. Equipped with at least the buyer's purchasing score and/or the purchase intent, the offer source can calculate for the buyer appropriate incentives to formulate an offer.

At block 518, the intent platform receives one or more offers from the one or more offer sources. As indicated above, the intent platform can communicate with one or more offer sources and each source can be a primary source or a secondary source that queries a plurality of primary sources. In either case, the intent platform will collect the one or more offers from each of the offer sources and compile them such that the buyer can easily view and compare the offers.

At block 520, subsequent to receiving the one or more offers from the offer sources, the intent platform will provide them in a displayable format to the buyer. In one instance, the intent platform generates a list of the offers as shown in FIG. 4 on a computer equipped with Internet access. In another embodiment, the generated list of offers is transmitted to the user using a user-specific transmission mechanism such as e-mail or on personal computing device. In one embodiment, each offer listed may include a link to a corresponding primary source and an option to tentatively accept the offer to conditionally receive the discount.

In various embodiments, the intent platform can be implemented with other services or applications. For example, the intent platform can integrate a buyer's activity or purchase experience with the buyer's social media account. The features of the social media platform allow a buyer to involve other members within his/her network by, for instance, recommending the offer to other members or purchasing as a group. As such, a buyer's purchasing score can be positively impacted with the prospect of additional buyers, mass quantities, and greater amount being spent. For example when a buyer accepts an offer and completes the transaction to make a purchase, the buyer is able to publicize his or her offer activity and/or purchase experience with an offer source by making a recommendation to other members on the social media account. In the recommendation, the buyer is able to choose certain aspects of the activity or purchase experience to publicize. In one embodiment, a buyer can select not to reveal the transaction time of the activity and/or purchase experience. Other aspects that may be suppressed include the amount spent on a transaction, the type of product/service purchased, and other specific details of the offer(s).

The platform can monetize its services in a variety of ways. In one embodiment, the revenue model centers on lead generation, or the creation and generation of prospective consumer interest or inquiries into products or services of a business. For example, if a buyer broadcasts a purchase intent for a lawnmower, a fee can be assessed on businesses providing home improvement services or products in exchange for a potential consumer. The pricing structure can have a variety of bases including, but not limited to, use-based, percentage, flat, variable, hybrid, etc. In other embodiments, fees can be assessed at various times such as when an offer is converted into a transaction or when a buyer pays-in-advance. In another embodiment, monetization can be based on access to the results of the platform's data analytics or the opportunity to provide advertisements. Further, the platform can also be utilized for non-profit or charitable purposes.

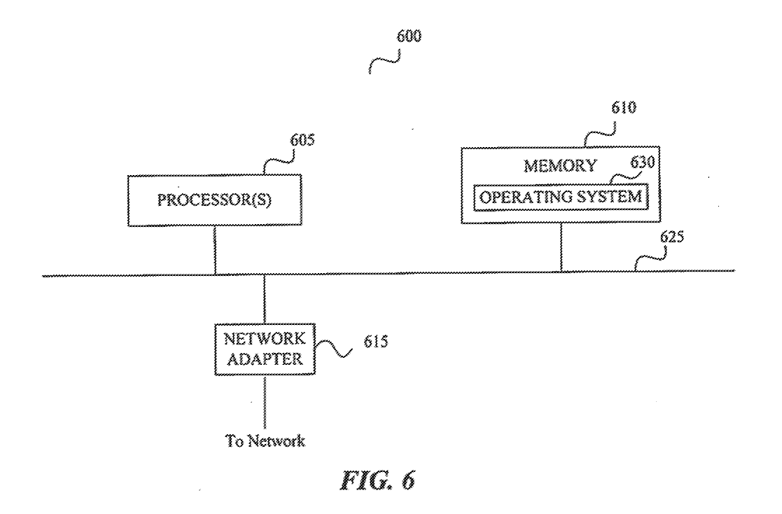

FIG. 6 is a high-level block diagram showing an example of the architecture for a computer system 600 that can be utilized to implement an intent server (e.g., 114 from FIG. 1), a web server (e.g., 125 from FIG. 1), etc. In FIG. 6, the computer system 600 includes one or more processors 605 and memory 610 connected via an interconnect 625. The interconnect 625 is an abstraction that represents any one or more separate physical buses, point to point connections, or both connected by appropriate bridges, adapters, or controllers. The interconnect 625, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 694 bus, sometimes referred to as “Firewire”.

The processor(s) 605 may include central processing units (CPUs) to control the overall operation of, for example, the host computer. In certain embodiments, the processor(s) 605 accomplish this by executing software or firmware stored in memory 610. The processor(s) 605 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 610 is or includes the main memory of the computer system 1100. The memory 610 represents any form of random access memory (RAM), read-only memory (ROM), flash memory (as discussed above), or the like, or a combination of such devices. In use, the memory 610 may contain, among other things, a set of machine instructions which, when executed by processor 605, causes the processor 605 to perform operations to implement embodiments of the present invention.

Also connected to the processor(s) 605 through the interconnect 625 is a network adapter 615. The network adapter 615 provides the computer system 600 with the ability to communicate with remote devices, such as the storage clients, and/or other storage servers, and may be, for example, an Ethernet adapter or Fiber Channel adapter.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, white only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the invention.

We claim:

1. A method of converting an online interaction into a brick-and-mortar transaction by assessing buyer intent and providing offers based on intent and buyer purchasing score, the method comprising:
maintaining a database of buyer attributes;
receiving from a first buyer a request, on an intent server, for one or more offers;
determining a purchasing score of the first buyer based, at least in part, on information stored in the database of buyer attributes;
transmitting the request and the purchasing score to one or more offer sources;
receiving said one or more offers from said one or more offer sources; and
providing the one or more offers to the first buyer.

2. The method of claim 1, further comprising receiving registration information, wherein the registration information facilitates the determining of the first buyer's purchasing score.

3. The method of claim 1, wherein the database includes one or more demographics of the first buyer, the demographics including:
gender;
age;
income;
location;
residence;
educational attainment;
profession;
employment status;
home ownership;
disability; or
mobility.

4. The method of claim 1, wherein the request includes one or more parameters, the parameters including:
an estimated time of purchase;
an estimated amount of purchase; or
a category of purchase.

5. The method of claim 1, wherein the determining a purchasing score includes performing at least one of:
evaluating past behavior of the first buyer;
comparing an offer accepted by the first buyer to a corresponding past request;
considering a total amount spent on one or more offers accepted by the first buyer; or
considering a number of offers accepted by the first buyer.

6. The method of claim 1, wherein maintaining the database includes tracking:
number of past requests from the first buyer;
number of offers accepted by the first buyer;
comparison of an offer accepted by the first buyer to a corresponding past request;
category of past requests;
time since an offer was accepted by the first buyer;
total amount spent on an offer accepted by the first buyer;
prevalence of offers accepted by the first buyer; or
amount of time the first buyer's information has been stored in the database.

7. The method of claim 1, wherein the determining a purchasing score includes increasing the purchasing score when the first buyer accepts at least one of the offers provided to the first buyer.

8. The method of claim 1, wherein the determining a purchasing score includes increasing the purchasing score when an offer accepted by the buyer is substantially similar to a corresponding brick-and-mortar transaction.

9. The method of claim 1, further comprising assessing a fee on the one or more offer sources.

10. The method of claim 9, wherein the fee is assessed upon:
providing the one or more offers to the first buyer; or
acceptance by the first buyer of the one or more offer sources.

11. The method of claim 9, wherein at least a portion of the fee is proportional to a value of the one or more offers accepted by the first buyer.

12. The method of claim 1 further comprising assessing a fee on the first buyer.

13. The method of claim 12, wherein the fee is assessed in response to:
receiving from the first buyer the request for the one or more offers;
transmitting the request and the purchasing score to the one or more offer sources;
receiving the one or more offers from said one or more offer sources; or
an acceptance by the first buyer of one of the one or more offers.

14. The method of 12, wherein at least a portion of the fee is proportional to a value of the one or more offers accepted by the first buyer.

15. The method of claim 1, wherein the determining a purchasing score includes behavior of the first buyer on a social network.

16. The method of claim 15, wherein the first buyer's behavior includes making a recommendation to another member on the social network.

17. The method of claim 16, wherein the first buyer purges particular aspects of the recommendation to share with other members, the particular aspects including:
specific details of the one or more offers;
time of transaction;
amount of transaction; or
category of transaction.

18. The method of claim 1, wherein the offer source includes a local database, wherein the local database stores one or more offers retrieved from a plurality of primary sources, each of the plurality of primary sources correspond to an entity through which the buyer can accept the offer.

19. A method of converting an online interaction into a transaction at a physical store by assessing a buyer's purchasing intent and providing offers based on the purchasing intent and buyer purchasing score, the method comprising:
maintaining a database of buyer attributes;
receiving from a first buyer a purchasing intent, on an intent server, for one or more offers, wherein the request includes a plurality of parameters, the parameters including:
an estimate of time;
an estimate of amount; and
a category;
determining the purchasing score of the first buyer based, at least in part, on information stored in the database of buyer attributes;
transmitting the request and the purchasing score to one or more offer sources; and
providing the one or more offers to the first buyer.

20. The method of claim 19, further comprises receiving registration information, wherein the registration information facilitates the determining of the purchasing score of the first buyer.

21. The method of claim 19, wherein the buyer attributes include a plurality of demographics, the demographics including one of the following
gender;
age;
income;
location;
residence;
educational attainment;
profession;
employment status;
home ownership;
disability; or
mobility.

22. The method of claim 19, wherein the determining a purchasing score includes performing at least one of:
evaluating past behavior of the first buyer;
comparing of an offer accepted by the first buyer to a corresponding past purchasing intent;
considering a total amount spent on one or more offers accepted by the first buyer; or
considering a number of offers accepted by the first buyer.

23. The method of claim 19, wherein the determining a purchasing score includes tracking:
number of past purchasing intents from the first buyer;
number of offers accepted by the first buyer;
comparison of an offer accepted by the first buyer to a corresponding past purchasing intent;
category of past purchasing intents;
time since an offer was accepted by the first buyer;
total amount spent on an offer accepted by the first buyer;
prevalence of offers accepted by the first buyer; or
amount of time the first buyers information has been stored in the database.

24. The method of claim 19, wherein the determining a purchasing score includes increasing the purchasing score when the buyer accepts at least one of the offers provided to the first buyer.

25. The method of claim 19, wherein the determining a purchasing score includes increasing the purchasing score when an offer accepted by a buyer is substantially similar to a corresponding brick-and-mortar transaction.

26. The method of claim 19, further comprising: assessing a fee on the one or more offer sources.

27. The method of claim 26, wherein the fee is assessed upon:
providing the one or more offers to the first buyer; or
acceptance by the first buyer of the one or more offer sources.

28. The method of claim 26, wherein at least a portion of the fee is proportional to a value of the one or more offers accepted by the first buyer.

29. The method of claim 19, further comprising: assessing a fee on the first buyer.

30. The method of claim 29, wherein the fee is assessed in response to:
receiving from the first buyer the purchasing intent for the one or more offers;
transmitting the purchasing intent and the purchasing score to the one or more offer sources;
receiving the one or more offers from said one or more offer sources; or
an acceptance by the first buyer of one of the one or more offers.

31. The method of 30, wherein at least a portion of the fee is proportional to a value of the one or more offers accepted by the first buyer.

32. The method of claim 19, wherein the determining a purchasing score includes behavior of the first buyer on asocial network.

33. The method of claim 32, wherein the first buyer's behavior includes making a recommendation to another member on the social network.

34. The method of claim 33, wherein the first buyer purges particular aspects of the recommendation to share with other members, the particular aspects including:
specific details of the one or more offers;
time of transaction;
amount of transaction; or
category of transaction.

35. The method of claim 19, wherein the offer source includes a local database, wherein the local database stores one or more offers retrieved from a plurality of primary sources, each of the plurality of primary sources correspond to an entity through which the first buyer can accept the offer.

36. A system of converting an online interaction into a transaction at a physical store by assessing buyer intent and providing offers based on a purchasing intent and buyer purchasing score, the system comprising:
a maintaining module configured to maintain a database of buyer attributes;
a receiving module, on an intent server, configured to receive from a first buyer a request for one or more offers;
a determining module configured to calculate a purchasing score of the first buyer based, at least in part, on information stored in the database of buyer attributes;
a transmitting module configured to transmit the request and the purchasing score to one or more offer sources;
the receiving module further configured to receive said one or more offers from said one or more offer sources; and
a providing module configured to provide the one or more offers to the first buyer.

37. The system of claim 36, wherein the receiving module is further configured to receive registration information, wherein the registration information facilitates the determining of the first buyer's purchasing score.

38. The system of claim 36, wherein the database includes one or more demographics of the first buyer, the demographics including:
gender;
age;
income;
location;
residence;
educational attainment;
profession;
employment status;
home ownership;
disability; or
mobility.

39. The system of claim 36, wherein the request includes one or more parameters, the parameters including at least one of:
an estimated time of purchase;
an estimated amount of purchase; or
a category of purchase.

40. The system of claim 36, wherein the calculating module is further configured to:
evaluate past behavior of the first buyer;
compare an offer accepted by the first buyer to a corresponding past request;
determine a total amount spent on one or more offers accepted by the first buyer; and
determine number of offers accepted by the first buyer.

41. The system of claim 36, wherein the calculating module is further configured to track:
number of past requests from the first buyer;
number of offers accepted by the first buyer;
comparison of an offer accepted by the first buyer to a corresponding past request;
category of past requests;
time since an offer was accepted by the first buyer;
total amount spent on an offer accepted by the first buyer;
prevalence of offers accepted by the first buyer; or
amount of time the first buyer's information has been stored in the database.

42. The system of claim 36, wherein the calculating module further includes increasing the purchasing score when the first buyer accepts at least one of the offers provided to the first buyer.

43. The system of claim 36, wherein the calculating module further includes increasing the purchasing score when an offer accepted by a buyer is substantially similar to a corresponding brick-and-mortar transaction.

44. The system of claim 36, further comprising an assessing module configured to assess a fee on the one or more offer sources.

45. The system of claim 44, wherein assessing module is further configured to assess the fee upon:
providing the one or more offers to the first buyer; or
acceptance by the first buyer of the one or more offer sources.

46. The system of claim 44, wherein at least a portion of the fee is proportional to a value of the one or more offers accepted by the first buyer.

47. The system of claim 36 further comprising an assessing module configured to assess a fee on the first buyer.

48. The system of claim 46, wherein the assessing module is configured to assess a fee in response to:
receiving the request for the one or more offers;
transmitting the request and the purchasing score to the one or more offer sources;
receiving the one or more offers from said one or more offer sources; or
an acceptance by the first buyer of one of the one or more offers.

49. The system of claim 36, wherein the determining module is further configured to account for a behavior of the first buyer on a social network.

50. The system of claim 48 wherein the first buyer's behavior Includes making a recommendation to another member on the social network.

51. The system of claim 49, wherein the first buyer purges particular aspects of the recommendation to share with other members, the particular aspects including:
specific details of the one or more offers;
time of transaction;
amount of transaction; or
category of transaction.

52. The system of claim 36, wherein the offer source includes a local database, wherein the local database stores one or more offers retrieved from a plurality of primary sources, each of the plurality of primary sources correspond to an entity through which the first buyer can accept the offer.

53. A method of converting an online interaction between users into a transaction by assessing an intent of a first user and providing offers based on the intent and the first users purchasing score, the method comprising:
maintaining a database of user attributes;
receiving from a first user a request, on an intent server, for one or more offers;
determining a purchasing score of the first user based, at least in part, on information stored in the database of user attributes;
transmitting the request and the purchasing score to a plurality of offer providers, the plurality of offer providers including users other than the first user;
receiving said one or more offers from said one or more offer providers; and
displaying the one or more offers to the first user.

54. The method of claim 52, wherein the request from the first user includes one or more parameters, including:
an estimated time of purchase;
an estimated amount of purchase;
a location of the first user; or
a category of purchase.

55. The method of claim 52, wherein the determining a purchasing score includes performing at least one of:
evaluating past behavior of the first user;
comparing an offer accepted by the first user to a corresponding past request;
considering a total amount spent on one or more offers accepted by the first user; or
considering a number of offers accepted by the first buyer.

56. The method of claim 52, wherein the maintaining a database includes tracking:
number of past requests from the first user;
number of offers accepted by the first user;
number of offers immediately purchased by the first user;
comparison of an offer accepted by the first user to a corresponding past request;
category of past requests;
time since an offer was accepted by the first user;
total amount spent on an offer accepted by the first user;
prevalence of offers accepted by the first user; or
amount of time the first buyer's information has been stored in the database.

57. A method of converting an online interaction into a purchase by assessing a buyer's purchasing intent and providing offers based on the purchasing intent and buyer purchasing score, the method comprising:
maintaining a database of buyer attributes;
receiving from a first buyer a purchasing intent, on an intent server, for one or more offers, wherein the request includes a plurality of parameters, the parameters including:
an estimate of time;
an estimate of amount; and
a category;
determining the purchasing score of the first buyer based, at least in part, on information stored in the database of buyer attributes;
transmitting the request and the purchasing score to one or more offer sources; and
providing the one or more offers to the first buyer such that the first buyer can convert at least one offer into a purchase.

58. The method of claim 57, further comprising: transferring the first buyer to the website of the at least one offer to complete the purchase.

59. The method of claim 57, further comprising: receiving payment information from the first buyer to complete the purchase of the at least one offer.

60. The method of claim 59, further comprising: coordinating a delivery or a scheduling of the purchase.

61. The method of claim 57, wherein the determining a purchasing score includes performing at least one of:
evaluating past behavior of the first buyer;
comparing an offer accepted by the first buyer to a corresponding past request;
considering a total amount spent on one or more offers accepted by the first buyer;
considering a number of offers accepted by the first buyer; or
considering a number of offers immediately purchased by the first buyer.
